(19) United States
(12) Patent Application Publication
(10) Pub. No.: US 2023/0134722 A1
(43) Pub. Date: May 4, 2023

(54) MONOLITHIC ULTRASONIC FLOW METER AND PARTICLE DETECTION SYSTEM

(71) Applicant: Texas Instruments Incorporated, Dallas, TX (US)

(72) Inventors: Yanbo He, Irvine, CA (US); Bichoy Bahr, Allen, TX (US); Swaminathan Sankaran, Allen, TX (US)

(21) Appl. No.: 17/513,523

(22) Filed: Oct. 28, 2021

(51) Int. Cl. G01F 1/66

(52) U.S. Cl. CPC G01F 1/662; G01F 1/667

(57) ABSTRACT

An ultrasonic fluid flow measurement system includes an ultrasonic transducer having a semiconductor substrate and an interconnect region over the semiconductor substrate. The ultrasonic transducer has two arrays of ferroelectric resonators in the interconnect region. The arrays of ferroelectric resonators are parallel to a fluid boundary surface of a fluid flow channel attached to the ultrasonic transducer. The ultrasonic transducer includes a transmitter circuit and a detector circuit coupled to the arrays of ferroelectric resonators. The transmitter circuit and the detector circuit include active components in the semiconductor substrate. The ultrasonic fluid flow measurement system may be configured to measure speeds of particles in fluids in the fluid flow channel. The ultrasonic fluid flow measurement system may also be used to measure flow speeds of a fluid in the fluid flow channel.

### TECHNICAL FIELD

This description relates to the field of ultrasonic systems. More particularly, but not exclusively, this description relates to flow meters and particle detection in ultrasonic systems.

### BACKGROUND

Flow meters may be used to measure flow speeds of fluids in a wide variety of applications. The fluids may include pure water, seawater, polluted or dirty water, petrochemicals, industrial fluids such as acidic solutions, alkaline solutions, and solvents, agricultural fluids such as milk or fertilizer, and fluids used in health care, such as drugs, saline solutions, and blood. Ultrasonic flow meters utilize ultrasonic waves, which are acoustic waves having frequencies above 20 kilohertz (kHz).

### SUMMARY

This description described an ultrasonic transducer formed on a substrate including a semiconductor material, with an interconnect region on the substrate. The ultrasonic transducer includes an array of first ferroelectric resonators and an array of second ferroelectric resonators, both in the interconnect region, with ultrasonic reflectors in the interconnect region at one end of the array of first ferroelectric resonators and at one end of the array of second ferroelectric resonators. The ultrasonic transducer further includes a transmitter circuit including first active components in the semiconductor material, configured to actuate the first ferroelectric resonators to provide a transmitted ultrasonic signal, and a detector circuit including second active components in the semiconductor material, configured to detect a received ultrasonic signal acquired by the second ferroelectric resonators.

This description described an ultrasonic fluid flow measurement system including an ultrasonic transducer formed on a substrate including a semiconductor material, with an interconnect region on the substrate. The ultrasonic transducer includes an array of first ferroelectric resonators and an array of second ferroelectric resonators, both in the interconnect region. The ultrasonic transducer further includes a transmitter circuit including first active components in the semiconductor material, coupled to the array of first ferroelectric resonators. The transmitter circuit is configured to actuate the first ferroelectric resonators to emit an ultrasonic signal into a fluid flow channel acoustically coupled to the ultrasonic transducer. The ultrasonic transducer further includes a detector circuit including second active components in the semiconductor material, coupled to the array of second ferroelectric resonators. The detector circuit is configured to provide a detection signal corresponding to acquisition of a second ultrasonic signal from the fluid flow channel, by the second ferroelectric resonators.

This description described an ultrasonic fluid flow measurement system including an ultrasonic transducer formed on a substrate including a semiconductor material, with an interconnect region on the substrate. The ultrasonic transducer includes an array of first ferroelectric resonators and an array of second ferroelectric resonators, both in the interconnect region. The array of first ferroelectric resonators and the array of second ferroelectric resonators are parallel to a fluid boundary surface of a fluid flow channel attached to the ultrasonic transducer. The ultrasonic transducer further includes a transmitter circuit including first active components in the semiconductor material coupled to the array of first ferroelectric resonators. The transmitter circuit is configured to actuate the first ferroelectric resonators to emit an ultrasonic signal into the fluid flow channel. The ultrasonic transducer further includes a detector circuit including second active components in the semiconductor material, coupled to the array of second ferroelectric resonators. The detector circuit is configured to provide a detection signal corresponding to detection of a reflection of the ultrasonic signal from the fluid flow channel, by the second ferroelectric resonators

This description described an ultrasonic fluid flow measurement system including a first ultrasonic transducer and a second ultrasonic transducer. The first ultrasonic transducer is formed on a first substrate including a first semiconductor material, with a first interconnect region on the first substrate. The first ultrasonic transducer includes an array of first ferroelectric resonators in the first interconnect region, configured parallel to a first fluid boundary surface of a fluid flow channel attached to the first ultrasonic transducer. The first ultrasonic transducer further includes a transmitter circuit including first active components in the first semiconductor material, coupled to the array of first ferroelectric resonators. The transmitter circuit is configured to actuate the first ferroelectric resonators to emit an ultrasonic signal into the fluid flow channel. The second ultrasonic transducer is formed on a second substrate including a second semiconductor material, with a second interconnect region on the second substrate. The second ultrasonic transducer includes an array of second ferroelectric resonators in the second interconnect region, configured parallel to a second fluid boundary surface of the fluid flow channel. The second ultrasonic transducer is attached to the fluid flow channel. The second ultrasonic transducer further includes a detector circuit including second active components in the second semiconductor material, coupled to the array of second ferroelectric resonators. The detector circuit is configured to provide a detection signal corresponding to detection of a transmission of the ultrasonic signal through the fluid flow channel, by the second ferroelectric resonators.

### BRIEF DESCRIPTION OF THE VIEWS OF THE DRAWINGS

FIG. 1A and FIG. 1B are a top view and a cross section of an example ultrasonic transducer.

FIG. 2A and FIG. 2B are a top view and a cross section of another example ultrasonic transducer.

FIG. 3A and FIG. 3B are a top view and a cross section of a further example ultrasonic transducer.

FIG. 4 is a cross section of an example ultrasonic transducer, showing details of ferroelectric resonators.

FIG. 5 is a cross section of an example ultrasonic fluid flow measurement system.

FIG. 6 is a chart depicting example waveforms of the transmitted ultrasonic signals and the received ultrasonic signals, described in reference to FIG. 5.

FIG. 7 is a chart depicting example frequency spectra of the transmitted ultrasonic signals and the received ultrasonic signals, described in reference to FIG. 5 and FIG. 6.

FIG. 8 is a cross section of another example ultrasonic fluid flow measurement system.

FIG. 9 is a chart depicting example waveforms of the transmitted ultrasonic signals and the received ultrasonic signals, described in reference to FIG. 8.

FIG. 10 is a cross section of another example ultrasonic fluid flow measurement system.

FIG. 11 is a chart depicting example waveforms of the transmitted ultrasonic signals and the received ultrasonic signals, described in reference to FIG. 10.

FIG. 12 is a cross section of another example ultrasonic fluid flow measurement system.

FIG. 13 depicts a cutaway view of an example ultrasonic fluid flow measurement system.

FIG. 14 depicts a cutaway view of another example ultrasonic fluid flow measurement system.

FIG. 15 depicts another example ultrasonic fluid flow measurement system.

### DETAILED DESCRIPTION

The drawings are not necessarily drawn to scale. This description is not limited by the illustrated ordering of acts or events, as some acts or events may occur in different orders and/or concurrently with other acts or events. Furthermore, some illustrated acts or events are optional.

Although some embodiments illustrated herein are shown in two-dimensional views with various regions having depth and width, those regions may illustrate a portion of a device that is actually a three-dimensional structure. Accordingly, those regions have three dimensions, including length, width and depth, when fabricated on an actual device.

In one aspect of this description, an ultrasonic transducer is formed on a substrate that includes a semiconductor material, and an interconnect region is formed on the substrate. An array of first ferroelectric resonators and an array of second ferroelectric resonators are formed in the interconnect region. Ultrasonic reflectors are formed in the interconnect region proximate to at least one end of the array of first ferroelectric resonators and proximate to at least one end of the array of second ferroelectric resonators. A transmitter circuit including first active components is formed in the semiconductor material and the interconnect region. The transmitter circuit is configured to actuate the first ferroelectric resonators, that is, to apply a potential difference across opposite surfaces of ferroelectric material in the first ferroelectric resonators, to provide a transmitted ultrasonic signal. A detector circuit including second active components is formed in the semiconductor material and the interconnect region. The detector circuit is configured to detect a received ultrasonic signal acquired by the second ferroelectric resonators. The received ultrasonic signal is the transmitted ultrasonic signal after transmission through a fluid.

In another aspect of this description, an ultrasonic fluid flow measurement system includes an ultrasonic transducer. The ultrasonic transducer includes a substrate with a semiconductor material, and an interconnect region on the substrate. The ultrasonic transducer includes an array of first ferroelectric resonators and an array of second ferroelectric resonators, both formed in the interconnect region. The ultrasonic transducer further includes a transmitter circuit configured to actuate the first ferroelectric resonators to emit a transmitted ultrasonic signal into a fluid flow channel. The transmitter circuit is coupled to the array of first ferroelectric resonators. The transmitter circuit includes first active components formed in the semiconductor material. The ultrasonic transducer further includes a detector circuit configured to provide a detection signal corresponding to acquisition of a received ultrasonic signal from the fluid flow channel, by the second ferroelectric resonators. The detector circuit is coupled to the array of second ferroelectric resonators. The detector circuit includes second active components formed in the semiconductor material. In one version of this aspect, the received ultrasonic signal may be a reflection of the transmitted ultrasonic signal. In another version, the ultrasonic fluid flow measurement system may include a second ultrasonic transducer, and the transmitted ultrasonic signal may be detected by the second ultrasonic transducer after passing through the fluid flow channel, while the received ultrasonic signal may be transmitted from the second ultrasonic transducer through the fluid flow channel. The ultrasonic fluid flow measurement system may be configured to operate in a pulse-echo mode, a doppler mode, or a combined pulse-echo and doppler mode.

In a further aspect of this description, an ultrasonic fluid flow measurement system includes an ultrasonic transducer. The ultrasonic transducer is attached to a fluid flow channel during fluid flow measurements. The ultrasonic transducer includes a substrate with a semiconductor material, and an interconnect region on the substrate. The ultrasonic transducer includes an array of first ferroelectric resonators and an array of second ferroelectric resonators, both in the interconnect region. The array of first ferroelectric resonators and the array of second ferroelectric resonators are parallel to an adjacent fluid boundary surface of the fluid flow channel. The ultrasonic transducer includes a transmitter circuit and a detector circuit. The transmitter circuit includes first active components in the semiconductor material coupled to the array of first ferroelectric resonators. The detector circuit includes second active components in the semiconductor material, coupled to the array of second ferroelectric resonators. The transmitter circuit is configured to actuate the first ferroelectric resonators to emit an ultrasonic signal into the fluid flow channel. The detector circuit is configured to provide a detection signal corresponding to detection of a reflection of the ultrasonic signal from the fluid flow channel, by the second ferroelectric resonators. The ultrasonic fluid flow measurement system may optionally include a user interface coupled to the ultrasonic transducer.

In another aspect of this description, an ultrasonic fluid flow measurement system includes a first ultrasonic transducer and a second ultrasonic transducer. The first ultrasonic transducer and the second ultrasonic transducer are attached to a fluid flow channel during fluid flow measurements. The first ultrasonic transducer includes a first substrate with a first semiconductor material, and a first interconnect region on the first substrate. The first ultrasonic transducer includes an array of first ferroelectric resonators and an array of second ferroelectric resonators, both in the first interconnect region. The array of first ferroelectric resonators and the array of second ferroelectric resonators are parallel to an adjacent first fluid boundary surface of the fluid flow channel. The first ultrasonic transducer includes a first transmitter circuit and a first detector circuit. The first transmitter circuit includes first active components in the first semiconductor material coupled to the array of first ferroelectric resonators. The first detector circuit includes second active components in the first semiconductor material, coupled to the array of second ferroelectric resonators. The first transmitter circuit is configured to actuate the first ferroelectric resonators to emit a first ultrasonic signal into the fluid flow channel. The first detector circuit is configured to provide a first detection signal corresponding to detection of a second ultrasonic signal from the fluid flow channel, by the second ferroelectric resonators. The second ultrasonic transducer includes a second substrate with a second semiconductor material, and a second interconnect region on the second substrate. The second ultrasonic transducer includes an array of third ferroelectric resonators and an array of fourth ferroelectric resonators, both in the second interconnect region. The array of third ferroelectric resonators and the array of fourth ferroelectric resonators are parallel to an adjacent second fluid boundary surface of the fluid flow channel. The second ultrasonic transducer includes a second transmitter circuit and a second detector circuit. The second transmitter circuit includes third active components in the second semiconductor material coupled to the array of third ferroelectric resonators. The second detector circuit includes fourth active components in the second semiconductor material, coupled to the array of fourth ferroelectric resonators. The second transmitter circuit is configured to actuate the third ferroelectric resonators to emit the second ultrasonic signal into the fluid flow channel. The second detector circuit is configured to provide a second detection signal corresponding to detection of the first ultrasonic signal from the fluid flow channel, by the fourth ferroelectric resonators.

For the purposes of this description, the term “ultrasonic” refers to frequencies above 20 kHz. The term “ferroelectric” refers to materials that have a spontaneous electric polarization that can be reversed by the application of an external electric field. Ferroelectric materials used in the ultrasonic transducers described herein are piezoelectric, that is, the ferroelectric materials generate potential differences in response to externally applied force, and generate forces in response to externally applied potential differences.

Terms such as top, bottom, over, and above may be used in this description. These terms do not limit the position or orientation of a structure or element, but they provide spatial relationships between structures or elements. For the purposes of this description, the term “lateral” refers to a direction parallel to a plane of a corresponding array of ferroelectric resonators.

The following commonly assigned patent applications include related material, and are incorporated herein by reference but are not admitted to be prior art with respect to this description by their mention in this section: U.S. patent application Ser. No. 17/463,013, titled “ACOUSTIC WAVEGUIDE WITH DIFFRACTION GRATING”, filed Aug. 31, 2021, and U.S. patent application Ser. No. 16/590,354, titled “HIGH FREQUENCY CMOS ULTRASONIC TRANSDUCER”, filed Oct. 1, 2019, published as U. S. Patent Application Publication 2021/0099237 A1.

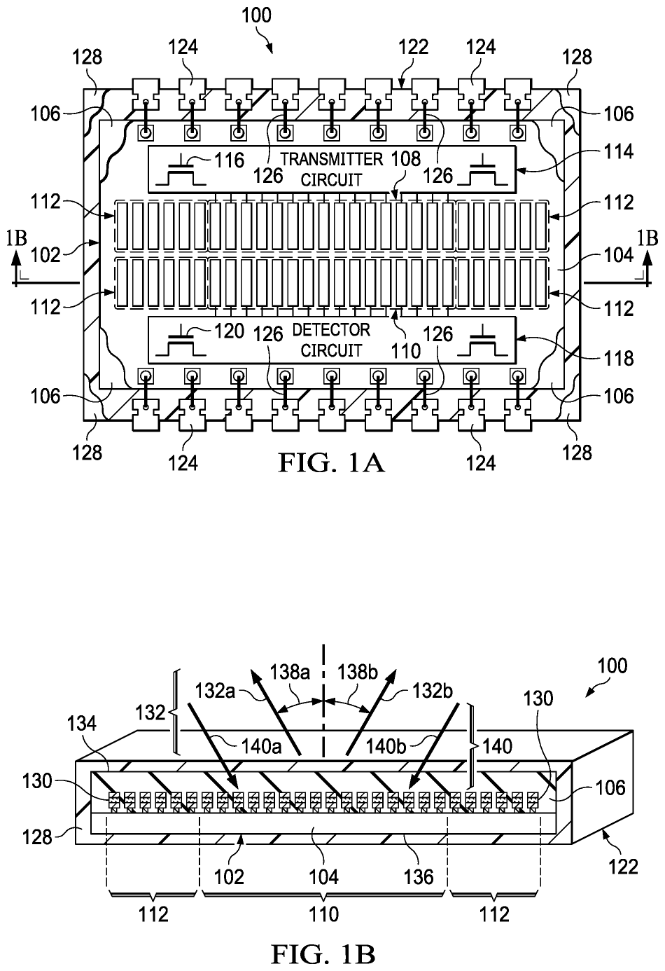

FIG. 1A and FIG. 1B are a top view and a cross section of an example ultrasonic transducer 100. Referring to FIG. 1A, the ultrasonic transducer 100 includes a substrate 102. The substrate 102 may be a singulated portion of a semiconductor wafer, such as a bulk silicon wafer or a silicon-on-insulator (SOI) wafer, by way of example. Other manifestation of the substrate 102 are within the scope of this example. The substrate 102 includes a semiconductor material 104, such as monocrystalline silicon. The ultrasonic transducer 100 includes an interconnect region 106 formed on the substrate 102. The interconnect region 106 includes several interconnect levels, not shown, with each interconnect level including metal interconnect lines. The interconnect region 106 further includes metal vias that connect the metal interconnect lines of sequential interconnect levels, and contacts that connect the metal interconnect lines of a first interconnect level with active components formed in the semiconductor material 104.

The ultrasonic transducer 100 includes an array of first ferroelectric resonators 108 formed in the interconnect region 106. The ultrasonic transducer 100 includes an array of second ferroelectric resonators 110 formed in the interconnect region 106. In this example, the array of first ferroelectric resonators 108 may be arranged parallel to the array of second ferroelectric resonators 110, as depicted in FIG. 1A. The ultrasonic transducer 100 includes ultrasonic reflectors 112 at both ends of the array of first ferroelectric resonators 108 and at both ends of the array of second ferroelectric resonators 110. The ultrasonic reflectors 112 are formed in the interconnect region 106, and may include ferroelectric resonators similar to the first ferroelectric resonators 108 and the second ferroelectric resonators 110.

The ultrasonic transducer 100 includes a transmitter circuit 114. The transmitter circuit 114 includes first active components 116 formed in the semiconductor material 104. The transmitter circuit 114 is coupled to the array of first ferroelectric resonators 108, as indicated in FIG. 1A. The transmitter circuit 114 may be coupled to the array of first ferroelectric resonators 108 through the metal interconnect lines and metal vias of the interconnect region 106.

The ultrasonic transducer 100 includes a detector circuit 118. The detector circuit 118 includes second active components 120 formed in the semiconductor material 104. The detector circuit 118 is coupled to the array of second ferroelectric resonators 110, as indicated in FIG. 1A. The detector circuit 118 may be coupled to the array of second ferroelectric resonators 110 through the metal interconnect lines and metal vias of the interconnect region 106.

The ultrasonic transducer 100 includes a microelectronic package 122 which contains the substrate 102 and the interconnect region 106. The microelectronic package 122 of this example includes external leads 124. The external leads 124 may be parts of a lead frame assembly, by way of example. The transmitter circuit 114 and the detector circuit 118 are coupled to the external leads 124, though wire bonds 126 in this example, as depicted in FIG. 1A. Other structures for coupling the transmitter circuit 114 and the detector circuit 118 to the external leads 124, such as solder bump bonds, are within the scope of this example. The microelectronic package 122 of this example includes a package material 128 that surrounds the substrate 102, the interconnect region 106, and the wire bonds 126, and holds the external leads 124 in place. The package material 128 may include epoxy, and may include filler particles to reduce a thermal expansion coefficient of the package material 128. Other compositions of the package material 128 are within the scope of this example.

Referring to FIG. 1B, the second ferroelectric resonators 110 may be configured as capacitors with ferroelectric material 130 between plates of the capacitors. The ferroelectric material 130 may include, by way of example, lead zirconium titanate or lead lanthanum zirconium titanate. The first ferroelectric resonators 108 of FIG. 1A, which are out of the plane of FIG. 1B, include the ferroelectric material 130, and may have structure similar to the second ferroelectric resonators 110.

The transmitter circuit 114 of FIG. 1A is configured to actuate the first ferroelectric resonators 108 to provide a transmitted ultrasonic signal 132. In this example, the transmitted ultrasonic signal 132 may be emitted through a top surface 134 of the interconnect region 106, as indicated in FIG. 1B. The top surface 134 of the interconnect region 106 is located opposite from a bottom surface 136 of the substrate 102. In this example, the transmitted ultrasonic signal 132 may include a first signal beam 132a and a second signal beam 132b. The first signal beam 132a may be emitted from the ultrasonic transducer 100 at a first angle 138a from a perpendicular direction to a plane of the first ferroelectric resonators 108 and the second ferroelectric resonators 110. The second signal beam 132b may be emitted from the ultrasonic transducer 100 at a second angle 138b from the perpendicular direction, opposite from the first signal beam 132a. The second angle 138b may be equal in magnitude to the first angle 138a. The first signal beam 132a and the second signal beam 132b may extend in a plane containing an axis of the first ferroelectric resonators 108 and the perpendicular direction to the plane of the first ferroelectric resonators 108 and the second ferroelectric resonators 110.

The detector circuit 118 of FIG. 1A is configured to detect a received ultrasonic signal 140 acquired by the second ferroelectric resonators 110 and provide a detection signal corresponding to the received ultrasonic signal 140. The received ultrasonic signal 140 of this example may be the transmitted ultrasonic signal 132 after transmission through a fluid, not shown in FIG. 1B. The received ultrasonic signal 140 of this example may include a first signal component 140a which is a reflection of the first signal beam 132a after transmission through the fluid, and may include a second signal component 140b which is a reflection of the second signal beam 132b after transmission through the fluid.

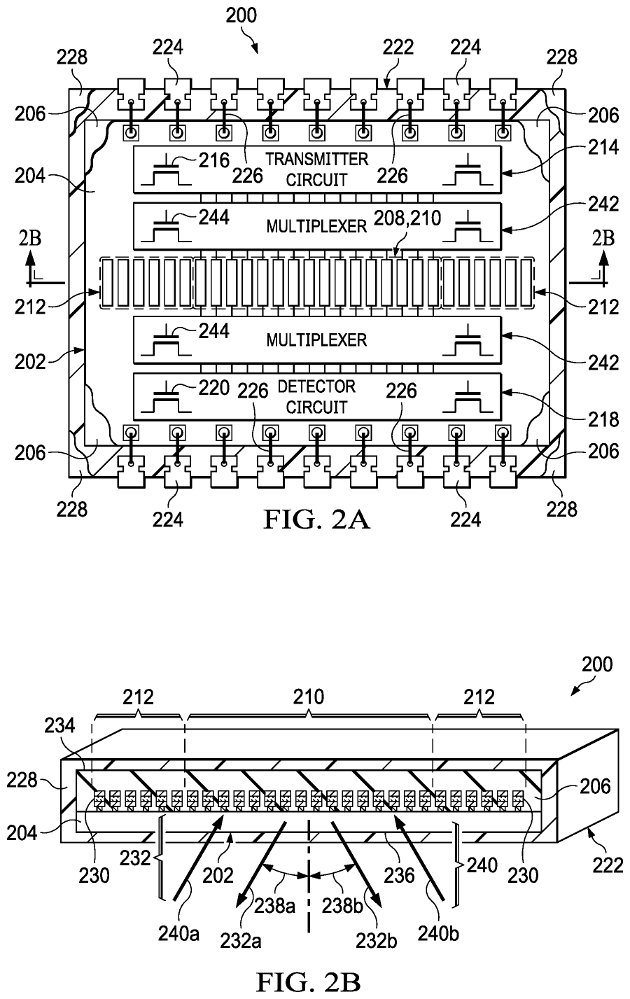

FIG. 2A and FIG. 2B are a top view and a cross section of another example ultrasonic transducer 200. Referring to FIG. 2A, the ultrasonic transducer 200 includes a substrate 202. The substrate 202 may be manifested as any of the examples described in reference to the substrate 102 of FIG. 1A. Other manifestation of the substrate 202 are within the scope of this example. The substrate 202 includes a semiconductor material 204, such as monocrystalline silicon. The ultrasonic transducer 200 includes an interconnect region 206 formed on the substrate 202. The interconnect region 206 includes several interconnect levels with metal interconnect lines, metal vias, and contacts as described in reference to the interconnect region 106 of FIG. 1A.

The ultrasonic transducer 200 of this example includes an array of first ferroelectric resonators 208 and an array of second ferroelectric resonators 210, both formed in the interconnect region 206. In this example, the first ferroelectric resonators 208 and the second ferroelectric resonators 210 comprise the same ferroelectric resonators. In this example, the arrays of first and second ferroelectric resonators 208 and 210 may be arranged in a single row, as depicted in FIG. 2A. The ultrasonic transducer 200 includes ultrasonic reflectors 212 at both ends of the arrays of first and second ferroelectric resonators 208 and 210. The ultrasonic reflectors 212 are formed in the interconnect region 206, and may include ferroelectric resonators similar to the first and second ferroelectric resonators 208 and 210.

The ultrasonic transducer 200 includes a transmitter circuit 214 which includes first active components 216 formed in the semiconductor material 204. The ultrasonic transducer 200 includes a detector circuit 218 which includes second active components 220 formed in the semiconductor material 204. The transmitter circuit 214 is coupled to the array of first ferroelectric resonators 208 through a multiplexer 242, as indicated in FIG. 2A. The multiplexer 242 includes third active components 244 formed in the semiconductor material 204. The detector circuit 218 is coupled to the array of second ferroelectric resonators 210 through the multiplexer 242, as indicated in FIG. 2A.

The ultrasonic transducer 200 includes a microelectronic package 222 which contains the substrate 202 and the interconnect region 206. The microelectronic package 222 of this example includes external leads 224, which may be parts of a lead frame assembly, by way of example. The transmitter circuit 214, the detector circuit 218, and the multiplexer 242 are coupled to the external leads 224, though wire bonds 226 in this example, as depicted in FIG. 2A. Other structures for coupling the transmitter circuit 214, the detector circuit 218, and the multiplexer 242 to the external leads 224, such as solder bump bonds, are within the scope of this example. The microelectronic package 222 of this example includes a package material 228 that surrounds the substrate 202, the interconnect region 206, and the wire bonds 226, and holds the external leads 224 in place. The package material 228 may have a composition as described in reference to the package material 128 of FIG. 1A. Other compositions of the package material 228 are within the scope of this example.

Referring to FIG. 2B, the first and second ferroelectric resonators 208 and 210 may be configured as capacitors with ferroelectric material 230 between plates of the capacitors. The ferroelectric material 230 may have a composition as described in reference to the ferroelectric material 130 of FIG. 1B.

The transmitter circuit 214 of FIG. 2A is configured to actuate the first ferroelectric resonators 208 to provide a transmitted ultrasonic signal 232. In this example, the transmitted ultrasonic signal 232 may be emitted through a bottom surface 236 of the substrate 202, as indicated in FIG. 2B. The bottom surface 236 of the substrate 202 is located opposite from a top surface 234 of the interconnect region 206. In this example, the transmitted ultrasonic signal 232 may include a first signal beam 232a and a second signal beam 232b. The first signal beam 232a may be emitted from the ultrasonic transducer 200 at a first angle 238a from a perpendicular direction to a plane of the first ferroelectric resonators 208 and the second ferroelectric resonators 210. The second signal beam 232b may be emitted from the ultrasonic transducer 200 at a second angle 238b from the perpendicular direction, opposite from the first signal beam 232a. The second angle 238b may be equal in magnitude to the first angle 238a. The first signal beam 232a and the second signal beam 232b may extend in a plane containing an axis of the first ferroelectric resonators 208 and the perpendicular direction to the plane of the first ferroelectric resonators 208 and the second ferroelectric resonators 210.

The detector circuit 218 of FIG. 2A is configured to detect a received ultrasonic signal 240 acquired by the second ferroelectric resonators 210 and provide a detection signal corresponding to the received ultrasonic signal 240. The received ultrasonic signal 240 of this example may be the transmitted ultrasonic signal 232 after transmission through a fluid, not shown in FIG. 2B. The received ultrasonic signal 240 of this example may include a first signal component 240a which is a reflection the first signal beam 232a after transmission through the fluid, and may include a second signal component 240b which is a reflection of the second signal beam 232b after transmission through the fluid.

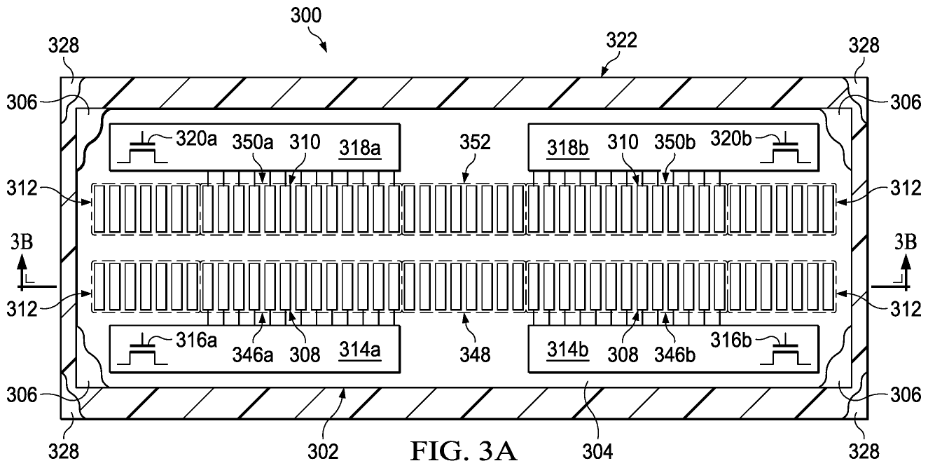

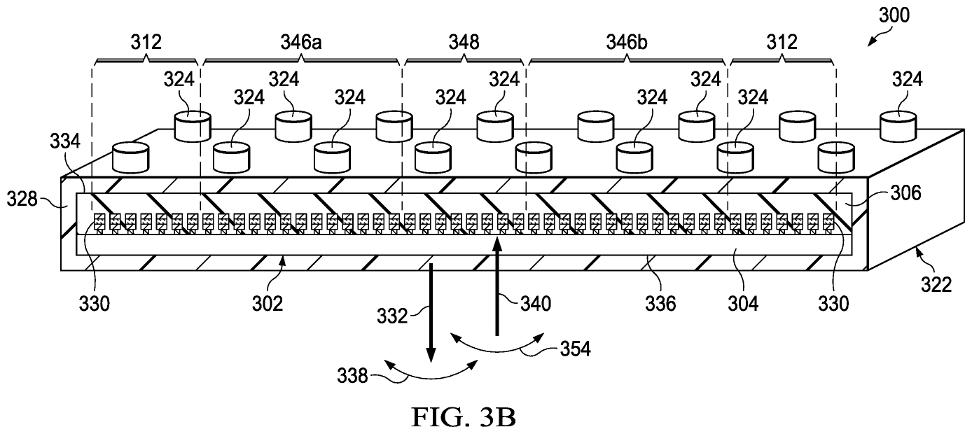

FIG. 3A and FIG. 3B are a top view and a cross section of a further example ultrasonic transducer 300. Referring to FIG. 3A, the ultrasonic transducer 300 includes a substrate 302. The substrate 302 may be manifested as any of the examples described in reference to the substrate 102 of FIG. 1A. Other manifestations of the substrate 302 are within the scope of this example. The substrate 302 includes a semiconductor material 304, such as monocrystalline silicon. The ultrasonic transducer 300 includes an interconnect region 306 formed on the substrate 302. The interconnect region 306 includes several interconnect levels with metal interconnect lines, metal vias, and contacts as described in reference to the interconnect region 106 of FIG. 1A.

The ultrasonic transducer 300 of this example includes an array of first ferroelectric resonators 308 and an array of second ferroelectric resonators 310, both formed in the interconnect region 306. In this example, the array of first ferroelectric resonators 308 may be arranged parallel to the array of second ferroelectric resonators 310, as depicted in FIG. 3A. In this example, the array of first ferroelectric resonators 308 may be arranged in a two subarrays, a first subarray 346a of the first ferroelectric resonators 308 and a second subarray 346b of the first ferroelectric resonators 308, with a transmitter grating 348 between the two subarrays 346a and 346b, as depicted in FIG. 3A. Similarly, the array of second ferroelectric resonators 310 may be arranged in a two subarrays, a first subarray 350a of the second ferroelectric resonators 310 and a second subarray 350b of the second ferroelectric resonators 310, with a receiver grating 352 between the two subarrays 350a and 350b, as depicted in FIG. 3A. The transmitter grating 348 and the receiver grating 352 are formed in the interconnect region 306, and may include ferroelectric resonators similar to the first and second ferroelectric resonators 308 and 310. The ultrasonic transducer 300 includes ultrasonic reflectors 312 at both ends of the arrays of first and second ferroelectric resonators 308 and 310. The ultrasonic reflectors 312 are formed in the interconnect region 306, and may include ferroelectric resonators similar to the first and second ferroelectric resonators 308 and 310.

The ultrasonic transducer 300 includes a first transmitter circuit 314a which includes first active components 316a formed in the semiconductor material 304, and a second transmitter circuit 314b which includes second active components 316b formed in the semiconductor material 304. The first transmitter circuit 314a is coupled to the first subarray 346a of the first ferroelectric resonators 308, for example, through the metal interconnect lines and metal vias of the interconnect region 306. The second transmitter circuit 314b is coupled to the second subarray 346b of the first ferroelectric resonators 308 in a manner similar to the first transmitter circuit 314a.

The ultrasonic transducer 300 includes a first detector circuit 318a which includes third active components 320a formed in the semiconductor material 304, and a second detector circuit 318b which includes fourth active components 320b formed in the semiconductor material 304. The first detector circuit 318a is coupled to the first subarray 350a of the second ferroelectric resonators 310, for example, through the metal interconnect lines and metal vias of the interconnect region 306. The second detector circuit 318b is coupled to the second subarray 350b of the second ferroelectric resonators 310 in a manner similar to the first detector circuit 318a.

The ultrasonic transducer 300 includes a microelectronic package 322 which contains the substrate 302 and the interconnect region 306. The microelectronic package 322 of this example includes external leads 324, shown in FIG. 3B, which may be solder bumps, by way of example. The first transmitter circuit 314a, the second transmitter circuit 314b, the first detector circuit 318a, and the second detector circuit 318b are coupled to the external leads 324 through the metal interconnect lines and metal vias of the interconnect region 306, in this example. The microelectronic package 322 of this example includes a package material 328 that surrounds the substrate 302 and the interconnect region 306, and provides support for the external leads 324. The package material 328 may have a composition as described in reference to the package material 128 of FIG. 1A. Other compositions of the package material 328 are within the scope of this example.

Referring to FIG. 3B, the first and second ferroelectric resonators 308 and 310 may be configured as capacitors with ferroelectric material 330 between plates of the capacitors. The ferroelectric material 330 may have a composition as described in reference to the ferroelectric material 130 of FIG. 1B.

The first transmitter circuit 314a of FIG. 3A is configured to actuate the first subarray 346a to produce a first transmitted signal component, and the second transmitter circuit 314b of FIG. 3A is configured to actuate the second subarray 346b to produce a second transmitted signal component. The first and second transmitted signal components combine in the transmitter grating 348 to provide a transmitted ultrasonic signal 332. In this example, the transmitted ultrasonic signal 332 may be emitted through a bottom surface 336 of the substrate 302, as indicated in FIG. 3B. The bottom surface 336 of the substrate 302 is located opposite from a top surface 334 of the interconnect region 306. The transmitted ultrasonic signal 332 is emitted at a transmission angle 338 from a perpendicular direction to a plane of the first ferroelectric resonators 308 and the second ferroelectric resonators 310. The transmission angle 338 depends on a first phase of the first transmitted signal component with respect to a second phase of the second transmitted signal component. The first transmitter circuit 314a may actuate the first subarray 346a to provide the first transmitted signal component with the first phase and the second transmitter circuit 314b may actuate the second subarray 346b to provide the second transmitted signal component with the second phase, to provide a desired value of the transmission angle 338. The first phase and the second phase may be varied with respect to each other during emission of the transmitted ultrasonic signal 332, so that the transmission angle 338 varies with time. In one version of this example, the first phase may be constant across all the first ferroelectric resonators 308 in the first subarray 346a, and the second phase may be constant across all the first ferroelectric resonators 308 in the second subarray 346b. In another version, the first phase may be varied across all the first ferroelectric resonators 308 in the first subarray 346a, so that separate instances of the first ferroelectric resonators 308 in the first subarray 346a are provided with different values of the first phase, and similarly for the second phase.

The first detector circuit 318a of FIG. 3A is configured to detect a received ultrasonic signal 340 acquired by the first subarray 350a of the second ferroelectric resonators 310 and provide a first detection signal corresponding to the received ultrasonic signal 340.

A received ultrasonic signal 340 induces vibrations in the receiver grating 352 which provides a first received signal component to the first subarray 350a of the second ferroelectric resonators 310, and provides a second received signal component to the second subarray 350b of the second ferroelectric resonators 310. The first detector circuit 318a of FIG. 3A is configured to detect the first received signal component acquired by the first subarray 350a of the second ferroelectric resonators 310 and provide a first detection signal corresponding to the first received signal component. The second detector circuit 318b of FIG. 3A is configured to detect the second received signal component acquired by the second subarray 350b of the second ferroelectric resonators 310 and provide a second detection signal corresponding to the first received signal component. The first received signal component has a first phase and the second received signal component has a second phase. A reception angle 354 of the received ultrasonic signal 340 from the perpendicular direction to a plane of the first ferroelectric resonators 308 and the second ferroelectric resonators 310 may be determined from the first and second phases of the first and second received signal components. The received ultrasonic signal 340 of this example may be the transmitted ultrasonic signal 332 after transmission through a fluid, not shown in FIG. 3B.

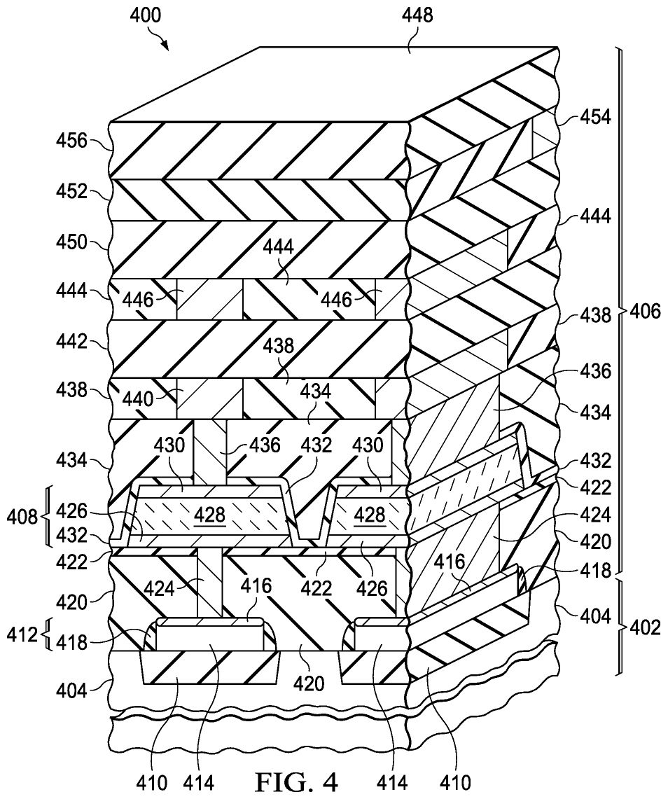

FIG. 4 is a cross section of an example ultrasonic transducer 400, showing details of ferroelectric resonators 408. The ultrasonic transducer 400 may be implemented in any of the ultrasonic transducers 100, 200, and 300 described in reference to FIG. 1A and FIG. 1B, FIG. 2A and FIG. 2B, and FIG. 3A and FIG. 3B, respectively. The ultrasonic transducer 400 includes a substrate 402. The substrate 402 may be manifested as any of the examples described in reference to the substrate 102 of FIG. 1A. Other manifestations of the substrate 402 are within the scope of this example. The substrate 402 includes a semiconductor material 404, such as monocrystalline silicon. The substrate 402 may include field oxide 410, depicted in FIG. 4 with a shallow trench isolation (STI) structure, having angled sides extending into the semiconductor material 404. Alternatively, the field oxide 410 may have a local oxidation of silicon (LOCOS) structure with tapered edges commonly referred to as “birds' beaks”. The ultrasonic transducer 400 includes active components, not shown in FIG. 4, such as transistors, in the substrate 402.

The ultrasonic transducer 400 includes an interconnect region 406 on the substrate 402. The ferroelectric resonators 408 are located in the interconnect region 406. The ultrasonic transducer 400 of this example includes lower bias lines 412 of polycrystalline silicon 414, commonly referred to as “polysilicon”, on the field oxide 410. The polysilicon 414 may be doped to improve a sheet resistance of the lower bias lines 412. The lower bias lines 412 have metal silicide 416 on the polysilicon 414 to further improve the sheet resistance of the lower bias lines 412. The metal silicide 416 may include titanium silicide, cobalt silicide, nickel silicide, or tungsten silicide, by way of example. Sidewalls 418 may be formed on sides of the polysilicon 414, to facilitate fabrication of transistors having the polysilicon 414 for gates. The sidewalls 418 may include silicon nitride, for example.

The interconnect region 406 includes a pre-metal dielectric (PMD) layer 420 over the substrate 402 and the lower bias lines 412. The PMD layer 420 is electrically non-conductive, and may include one or more sublayers of dielectric material. By way of example, the PMD layer 420 may include a PMD liner, not shown, of silicon nitride, on the substrate 402 and the lower bias lines 412. The PMD layer 420 may also include a planarized layer, not shown, of silicon dioxide-based dielectric material such as silicon dioxide, phosphosilicate glass (PSG), fluorinated silicate glass (FSG), or borophosphosilicate glass (BPSG), on the PMD liner. The PMD layer 420 may further include a PMD cap layer, not shown, of silicon nitride, silicon carbide, or silicon carbonitride, suitable for an etch-stop layer of a chemical-mechanical polish (CMP) stop layer, on the planarized layer. Other layer structures and compositions for the PMD layer 420 are within the scope of this example. The ultrasonic transducer 400 includes a lower hydrogen barrier 422 formed on the PMD layer 420. The lower hydrogen barrier 422 reduces hydrogen diffusion into the ferroelectric resonators 408 from the PMD layer 420. The lower hydrogen barrier 422 is electrically non-conductive and may include aluminum oxide or silicon nitride, by way of example. The lower hydrogen barrier 422 may be between 10 and 50 nanometers thick.

Contacts 424 of the ultrasonic transducer 400 are formed through the lower hydrogen barrier 422 and the PMD layer 420, making electrical connections to the lower bias lines 412. The contacts 424 are electrically conductive, and may include titanium adhesion layers on the lower bias lines 412 and the PMD layer 420, titanium nitride liners on the titanium adhesion layers, and tungsten cores on the titanium nitride liners. In some versions of this example, the contacts 424 may have lengths significantly greater than widths, as depicted in FIG. 4, wherein each of the lower bias lines 412 makes an electrical connection with a single, separate, instance of the contacts 424, which extends along the lower bias line 412. In other versions, the contacts 424 may have lengths equal to widths, and a plurality of the contacts 424 may connect to each of the lower bias lines 412.

Each of the ferroelectric resonators 408 includes a lower plate 426 formed on the lower hydrogen barrier 422, making electrical connections to the contacts 424. The lower plate 426 may include titanium aluminum nitride and iridium, by way of example. Each of the ferroelectric resonators 408 includes a ferroelectric material 428 on the lower plate 426. The ferroelectric material 428 may have any of the compositions described in reference to the ferroelectric material 130 of FIG. 1B. Each of the ferroelectric resonators 408 includes an upper plate 430 on the ferroelectric material 428. The upper plate 430 may include titanium aluminum nitride and iridium, by way of example. The upper plate 430 and the lower plate 426 may have similar compositions. The ultrasonic transducer 400 includes an upper hydrogen barrier 432 formed over the ferroelectric resonators 408. The upper hydrogen barrier 432 is electrically non-conductive and may have a composition and thickness similar to the lower hydrogen barrier 422.

The interconnect region 406 includes a first inter-level dielectric (ILD) layer 434 over the upper hydrogen barrier 432 The first ILD layer 434 is electrically non-conductive. The first ILD layer 434 may include one or more dielectric layers, such as an etch stop layer of silicon nitride, a planarized main dielectric layer of silicon dioxide-based material, and a cap layer of silicon carbonitride, by way of example. Other layer structures and compositions for the first ILD layer 434 are within the scope of this example.

The interconnect region 406 includes first vias 436 formed through the first ILD layer 434 and the upper hydrogen barrier 432 to make electrical connections to the upper plates 430. The first vias 436 are electrically conductive. In some versions of this example, the first vias 436 may have lengths significantly greater than widths, as depicted in FIG. 4, wherein a single, separate, instance of the first vias 436 makes an electrical connection with each of the lower bias lines 412, which extends along the upper plate 430. In other versions, the first vias 436 may have lengths equal to widths, and a plurality of the first vias 436 may connect to each of the upper plates 430. In some versions of this example, the first vias 436 may include tantalum nitride barriers and copper fill metal, formed by a damascene process. In other versions, the first vias 436 may include titanium adhesion layers on the upper plate 430 and the first ILD layer 434, titanium nitride liners on the titanium adhesion layers, and tungsten cores on the titanium nitride liners. Other structures and compositions for the first vias 436 are within the scope of this example.

The interconnect region 406 includes a first intra-metal dielectric (IMD) layer 438 formed on the first ILD layer 434, and first interconnect lines 440 formed on the first vias 436 and laterally surrounded by the first IMD layer 438. The first IMD layer 438 is electrically non-conductive, and includes one or more silicon dioxide-based dielectric materials. The first interconnect lines 440 are electrically conductive, and may include primarily aluminum with an adhesion layer of titanium nitride and a cap layer of titanium nitride, or may include primarily copper with a barrier liner of tantalum nitride, by way of example. Other compositions and structures for the first IMD layer 438 and the first interconnect lines 440 are within the scope of this example. A plurality of the first interconnect lines 440 are electrically connected to the ferroelectric resonators 408 through the first vias 436.

The interconnect region 406 includes a second ILD layer 442 over the first IMD layer 438 and the first interconnect lines 440. The interconnect region 406 further includes a second IMD layer 444 formed on the second ILD layer 442, and second interconnect lines 446 laterally surrounded by the second IMD layer 444. A plurality of the second interconnect lines 446 may overlie the first interconnect lines 440 that are electrically connected to the ferroelectric resonators 408, as indicated in FIG. 4, which may facilitate acoustically coupling an ultrasonic signal from the ferroelectric resonators 408 through a top surface 448 of the interconnect region 406. The second IMD layer 444 is electrically non-conductive, and may have a composition and structure similar to the first IMD layer 438. The second interconnect lines 446 may have a composition and structure similar to the first interconnect lines 440. Other compositions and structures for the second IMD layer 444 and the second interconnect lines 446 are within the scope of this example.

The interconnect region 406 includes a third ILD layer 450 over the second IMD layer 444 and the second interconnect lines 446. The interconnect region 406 further includes a third IMD layer 452 formed on the third ILD layer 450, and third interconnect lines 454 laterally surrounded by the third IMD layer 452. The third IMD layer 452 is electrically non-conductive, and may have a composition and structure similar to the second IMD layer 444. The third interconnect lines 454 may have a composition and structure similar to the second interconnect lines 446. Other compositions and structures for the third IMD layer 452 and the third interconnect lines 454 are within the scope of this example. In this example, the interconnect region 406 may be free of the third interconnect lines 454 directly over the ferroelectric resonators 408, as indicated in FIG. 4.

The interconnect region 406 may include additional interconnect levels above the third IMD layer 452 and the third interconnect lines 454, with each interconnect level having an ILD level, an IMD level on the ILD level, and interconnect lines on the ILD level, surrounded by the IMD level. The interconnect region 406 further includes a protective overcoat (PO) layer over all the interconnect levels, extending to the top surface 448 of the interconnect region 406. The PO layer 456 includes one or more layers of dielectric material, such as silicon dioxide, silicon nitride, silicon oxynitride, aluminum oxide, and polyimide. The PO layer 456 may have openings, not shown, for bond pads, not shown; the bond pads provide external connections for the active components in the substrate 402. The ultrasonic transducer 400 may include a package material, similar to the package material 128 of FIG. 1A and FIG. 1B, not shown in FIG. 4, surrounding the substrate 402 and the interconnect region 406. The ultrasonic transducer 400 may further include external leads, similar to the external leads 124 of FIG. 1A, not shown in FIG. 4, that are electrically connected to the bond pads.

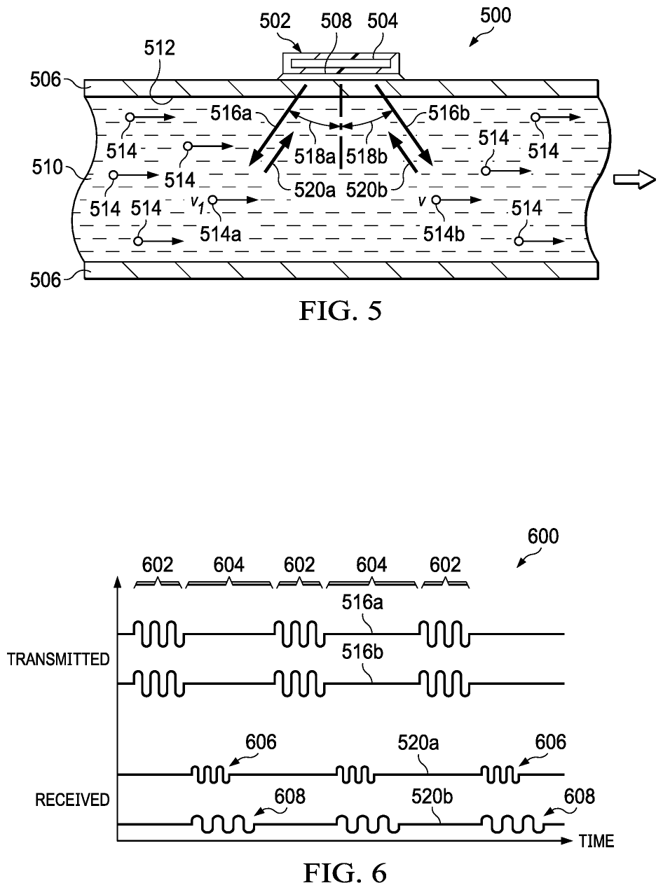

FIG. 5 is a cross section of an example ultrasonic fluid flow measurement system 500. The ultrasonic fluid flow measurement system 500 includes an ultrasonic transducer 502. The ultrasonic transducer 502 includes an array of ferroelectric resonators 504. The ultrasonic transducer 502 may be similar to any of the ultrasonic transducers 100, 200, and 300 described in reference to FIG. 1A and FIG. 1B, FIG. 2A and FIG. 2B, and FIG. 3A and FIG. 3B, respectively. The ultrasonic transducer 502 is acoustically coupled to a fluid flow channel 506. The ultrasonic transducer 502 may be acoustically coupled to the fluid flow channel 506 through an ultrasonic coupling material 508 such as an ultrasonic gel or an adhesive. The ultrasonic transducer 502 may be removably coupled to the fluid flow channel 506 or may be permanently attached to the fluid flow channel 506. During operation of the ultrasonic fluid flow measurement system 500, a fluid 510 may be flowing through the fluid flow channel 506. The fluid flow channel 506 has a fluid boundary surface 512 which contacts the fluid 510. The array of ferroelectric resonators 504 is parallel to the fluid boundary surface 512.

The fluid 510 contains particles 514 which flow with the fluid 510. The particles 514 thus have velocities with respect to the ultrasonic transducer 502, as indicated schematically in FIG. 5. During operation of the ultrasonic fluid flow measurement system 500, the ultrasonic transducer 502 may provide a first transmitted ultrasonic signal 516a. The first transmitted ultrasonic signal 516a is transmitted into the fluid 510 at a first angle 518a to a perpendicular direction from the fluid boundary surface 512. The first transmitted ultrasonic signal 516a may be reflected off one or more of the particles 514, referred to as first reflecting particles 514a, to provide a first received ultrasonic signal 520a which is acquired by the ultrasonic transducer 502. In the configuration depicted in FIG. 5, the first reflecting particles 514a are decreasing a first separation between the first reflecting particles 514a and the ultrasonic transducer 502, so a frequency of the first received ultrasonic signal 520a has a higher frequency than the first transmitted ultrasonic signal 516a, due to the Doppler effect. A first speed of the first reflecting particles 514a in the fluid 510 may be estimated using a difference in the frequency of the first received ultrasonic signal 520a and the first transmitted ultrasonic signal 516a. In one version of this example, the first and second transmitted ultrasonic signals 516a and 516b may be provided as continuous signals at a constant frequency. In another version of this example, the first and second transmitted ultrasonic signals 516a and 516b may be provided as transmitted bursts, and a first time period between transmission of the first transmitted ultrasonic signal 516a by the ultrasonic transducer 502 and acquisition of the first received ultrasonic signal 520a by the ultrasonic transducer 502 is a function of the first separation between the first reflecting particles 514a and the ultrasonic transducer 502, a speed of the first transmitted ultrasonic signal 516a in the fluid 510, and a speed of the first received ultrasonic signal 520a in the fluid 510. The first separation between the first reflecting particles 514a and the ultrasonic transducer 502 may be estimated using the first time period between transmission of the first transmitted ultrasonic signal 516a and acquisition of the first received ultrasonic signal 520a, the speed of the first transmitted ultrasonic signal 516a, and the speed of the first received ultrasonic signal 520a.

Also during operation of the ultrasonic fluid flow measurement system 500, the ultrasonic transducer 502 may provide a second transmitted ultrasonic signal 516b. The second transmitted ultrasonic signal 516b is transmitted into the fluid 510 at a second angle 518b to the perpendicular direction from the fluid boundary surface 512. The second transmitted ultrasonic signal 516b may be reflected off one or more of the particles 514, referred to as second reflecting particles 514b, to provide a second received ultrasonic signal 520b which is acquired by the ultrasonic transducer 502. In the configuration depicted in FIG. 5, the second reflecting particles 514b are increasing a separation between the second reflecting particles 514b and the ultrasonic transducer 502, so a frequency of the second received ultrasonic signal 520b has a lower frequency than the second transmitted ultrasonic signal 516b, due to the Doppler effect.

FIG. 6 is a chart 600 depicting example waveforms of the transmitted ultrasonic signals 516a and 516b and the received ultrasonic signals 520a and 520b, described in reference to FIG. 5. In this example, the first transmitted ultrasonic signal 516a may be provided as transmitted bursts 602 of pulses at an average transmitted frequency fₜ, separated by quiescent periods 604. The second transmitted ultrasonic signal 516a may be provided as transmitted bursts 602 and quiescent periods 604, concurrent with the first transmitted ultrasonic signal 516a.

The first received ultrasonic signal 520a may be manifested as first received bursts 606 of pulses at a first average received frequency fᵣ₁ that is higher than the average transmitted frequency fₜ of the transmitted bursts 602 of the first transmitted ultrasonic signal 516a. A detector circuit of the ultrasonic transducer 502 of FIG. 5 is configured to provide a first detection signal corresponding to the first received bursts 606. The first detection signal may be a frequency shift signal corresponding to a difference between the average transmitted frequency f_{t a}nd the first average received frequency fᵣ₁. A speed v₁ of the first reflecting particles 514a of FIG. 5 may be estimated using equation 1:

v₁=c₁×(fᵣ₁−fₜ)/[2×fₜ×sin(θ₁)] Equation 1

Where:

C₁ is the average speed of the first transmitted ultrasonic signal 516a and the first received ultrasonic signal 520a in the fluid 510, and

θ₁ is the first angle 518a of the first transmitted ultrasonic signal 516a, shown in FIG. 5.

The second received ultrasonic signal 520b may be manifested as second received bursts 608 of pulses at a second average received frequency fᵣ₂ that is lower than the average transmitted frequency fₜ of the transmitted bursts 602 of the second transmitted ultrasonic signal 516b. The detector circuit of the ultrasonic transducer 502 is configured to provide a second detection signal corresponding to the second received bursts 608. The second detection signal may be a frequency shift signal corresponding to a difference between the average transmitted frequency fₜ and the second average received frequency fᵣ₂. A speed v₂ of the second reflecting particles 514b of FIG. 5 may be estimated using equation 2:

v₂=c₂×(fᵣ₂−fₜ)/[2×fₜ×sin(θ₂)] Equation 2

Where:

C₂ is the average speed of the second transmitted ultrasonic signal 516b and the second received ultrasonic signal 520b in the fluid 510; generally, c₂ and c₂ are equal, and

θ₂ is the second angle 518b of the second transmitted ultrasonic signal 516b, shown in FIG. 5.

Other methods for estimating the speeds v₁ and v₂ are within the scope of this example. The method described in reference to FIG. 6 may also be used to count the particles 514 of FIG. 5 as the particles 514 flow by the ultrasonic transducer 502, by counting the received bursts 606 and 608.

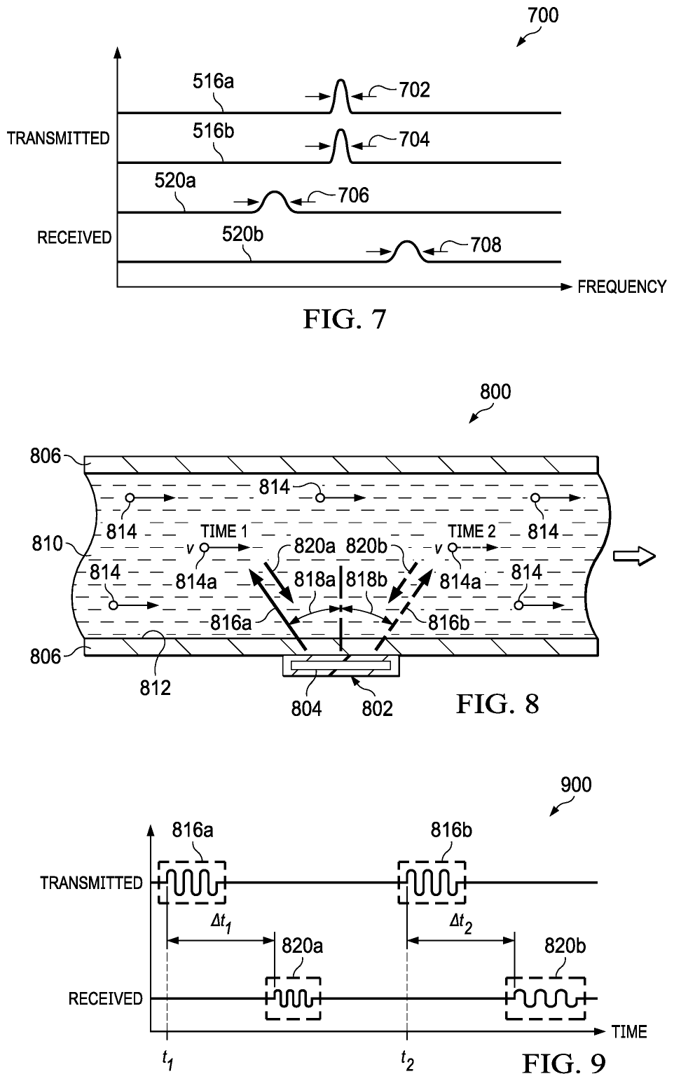

FIG. 7 is a chart 700 depicting example frequency spectra of the transmitted ultrasonic signals 516a and 516b and the received ultrasonic signals 520a and 520b, described in reference to FIG. 5. In this example, the first and second transmitted ultrasonic signals 516a and 516b may be provided as continuous signals or bursts. The first transmitted ultrasonic signal 516a has a first transmitted bandwidth 702 at the average ultrasonic frequency fₜ. The first transmitted bandwidth 702 may reflect shaping of the transmitted bursts 602 of FIG. 6. Similarly, the second transmitted ultrasonic signal 516b has a second transmitted bandwidth 704 at the average ultrasonic frequency fₜ. The first received ultrasonic signal 520a has a second received bandwidth 704 at the first average received frequency fᵣ₁. The first received bandwidth 706 is larger than the first transmitted bandwidth 702, due at least in part to variations in the speed v₁ of the first reflecting particles 514a of FIG. 5. Similarly, the second received bandwidth 708 is larger than the second transmitted bandwidth 704, due at least in part to variations in the speed v₂ of the second reflecting particles 514b of FIG. 5.

FIG. 8 is a cross section of another example ultrasonic fluid flow measurement system 800. The ultrasonic fluid flow measurement system 800 includes an ultrasonic transducer 802. The ultrasonic transducer 802 includes an array of ferroelectric resonators 804. The ultrasonic transducer 802 may be similar to the ultrasonic transducer 300 described in reference to FIG. 3A and FIG. 3B, for example. The ultrasonic transducer 802 is acoustically coupled to a fluid flow channel 806. During operation of the ultrasonic fluid flow measurement system 800, a fluid 810 may be flowing through the fluid flow channel 806. The fluid flow channel 806 has a fluid boundary surface 812 which contacts the fluid 810. The array of ferroelectric resonators 804 is parallel to the fluid boundary surface 812.

The fluid 810 contains a particles 814, including a reflecting particle 814a which flows with the fluid 810 at speed v, as indicated schematically in FIG. 8. During operation of the ultrasonic fluid flow measurement system 800, the ultrasonic transducer 802 may provide a first transmitted ultrasonic signal 816a at a first angle 818a at a first time t₁. The first angle 818a is determined with respect to a perpendicular direction from the fluid boundary surface 812. The first transmitted ultrasonic signal 816a may be reflected off the reflecting particles 814a to provide a first received ultrasonic signal 820a which is acquired by the ultrasonic transducer 802 after a first delay time Δt₁. A distance r₁ between the ultrasonic transducer 802 and the reflecting particles 814a at the time t₁ may be estimated using equation 3:

r₁=Δt₁×c/2 Equation 3

Where C is the average speed of the first transmitted ultrasonic signal 516a and the first received ultrasonic signal 520a in the fluid 510 at rest.

At a later time t₂, the ultrasonic transducer 802 may provide a second transmitted ultrasonic signal 816b at a second angle 818b. In FIG. 8, the second angle 818b is zero, that is, the second transmitted ultrasonic signal 816b is directed along the perpendicular direction from the fluid boundary surface 812. The second transmitted ultrasonic signal 816b may be reflected off the reflecting particles 814a to provide a second received ultrasonic signal 820b which is acquired by the ultrasonic transducer 802 after a second delay time Δt₂. A distance r₂ between the ultrasonic transducer 802 and the reflecting particles 814a at the time t₂ may be estimated using equation 3 by substituting Δt₂ for Δt₁.

A speed vₚ of the reflecting particles 814a may be estimated using equation 4:

vₚ=[r₂ sin(θ₂)−r₁ sin(θ₁)]/(t₂−t₁) Equation 4

Where:

θ₁ is the first angle 818a of the first transmitted ultrasonic signal 816a, shown in FIG. 8, and

θ₂ is the second angle 818b of the second transmitted ultrasonic signal 816b, shown in FIG. 8.

Other methods for estimating the distances r₁ and r₂ and estimating the speed vₚ using the delay times Δt₁ and Δt₂ and the angles 818a and 818b are within the scope of this example.

FIG. 9 is a chart 900 depicting example waveforms of the transmitted ultrasonic signals 816a and 816b and the received ultrasonic signals 820a and 820b, described in reference to FIG. 8. In this example, the first transmitted ultrasonic signal 816a may be provided as a burst of pulses at time t₁, followed by the second transmitted ultrasonic signal 816a, also manifested as a burst of pulses, at time t₂, separated by a and quiescent period.

The first received ultrasonic signal 820a may be manifested as a first burst of pulses, received at time t₁+Δt₁, that is, the first received ultrasonic signal 820a is received after the delay Δt₁, as indicated in FIG. 9. Similarly, the second received ultrasonic signal 820b may be manifested as a second burst of pulses, received at time t₂+Δt₂, as indicated in FIG. 9. A detector circuit of the ultrasonic transducer 802 of FIG. 8 is configured to provide a first detection signal corresponding to the first received ultrasonic signal 820a. The first detection signal may be a first delay time signal corresponding to the time difference Δt₁ between emission of the first transmitted ultrasonic signal 816a and detection of the first received ultrasonic signal 820a. Similarly, the detector circuit is configured to provide a second detection signal corresponding to the second received ultrasonic signal 820b; the first detection signal may be a second delay time signal corresponding to the time difference Δt₂ between emission of the second transmitted ultrasonic signal 816b and detection of the second received ultrasonic signal 820b.

The method described in reference to FIG. 9 may also be used to count the particles 814 of FIG. 8 as the particles 814 flow by the ultrasonic transducer 802, by counting the received ultrasonic signals 820a and 820b.

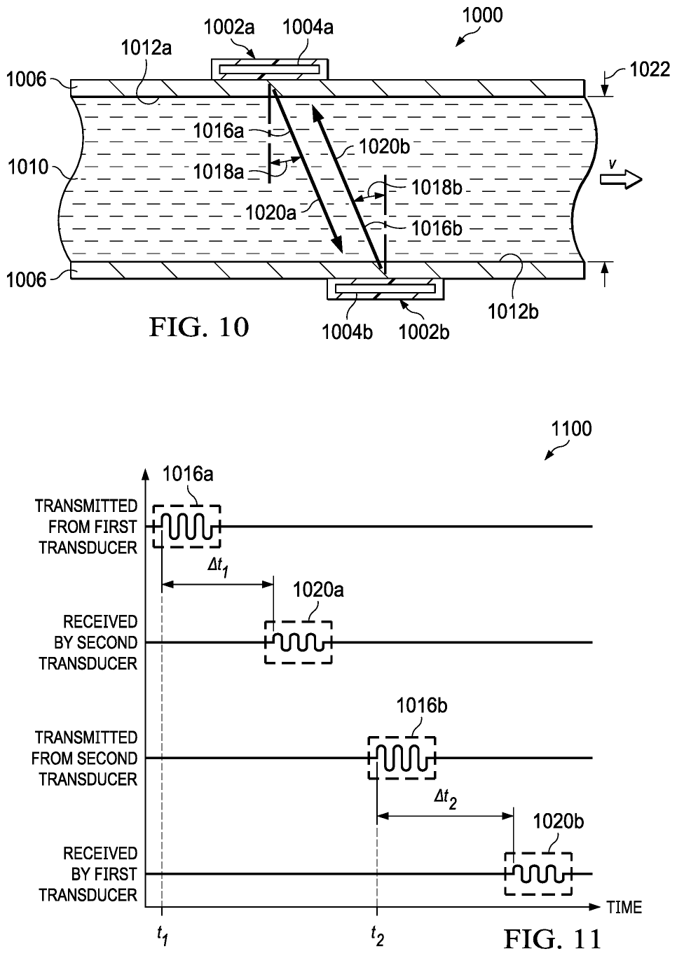

FIG. 10 is a cross section of another example ultrasonic fluid flow measurement system 1000. The ultrasonic fluid flow measurement system 1000 of this example includes a first ultrasonic transducer 1002a and a second ultrasonic transducer 1002b. The first ultrasonic transducer 1002a includes a first array of ferroelectric resonators 1004a, and the second ultrasonic transducer 1002b includes a second array of ferroelectric resonators 1004b. The ultrasonic transducers 1002a and 1002b may be similar to any of the ultrasonic transducers 100, 200, and 300 described in reference to FIG. 1A and FIG. 1B, FIG. 2A and FIG. 2B, and FIG. 3A and FIG. 3B, respectively. The first ultrasonic transducer 1002a and the second ultrasonic transducer 1002b are acoustically coupled to opposite sides of a fluid flow channel 1006, and laterally displaced from each other, as depicted in FIG. 10. During operation of the ultrasonic fluid flow measurement system 1000, a fluid 1010 may be flowing at speed v through the fluid flow channel 1006. The fluid flow channel 1006 has a first fluid boundary surface 1012a adjacent to the first ultrasonic transducer 1002a, and a second fluid boundary surface 1012b adjacent to the second ultrasonic transducer 1002b. The fluid 1010 contacts the first fluid boundary surface 1012a and the second fluid boundary surface 1012b. The first array of ferroelectric resonators 1004a is parallel to the first fluid boundary surface 1012a, and the second array of ferroelectric resonators 1004b is parallel to the second fluid boundary surface 1012b. The first fluid boundary surface 1012a is separated from the second fluid boundary surface 1012b by a distance w 1022 in a direction perpendicular to the first fluid boundary surface 1012a and the second fluid boundary surface 1012b.

During operation of the ultrasonic fluid flow measurement system 1000, the first ultrasonic transducer 1002a provides a first transmitted ultrasonic signal 1016a at a first angle 1018a toward the second ultrasonic transducer 1002b, at a first time t₁. The first angle 1018a is determined with respect to a perpendicular direction from the first fluid boundary surface 1012a. The first transmitted ultrasonic signal 1016a provides a first received ultrasonic signal 1020a which is acquired by the second ultrasonic transducer 1002b after a first delay time Δt₁. The first transmitted ultrasonic signal 1016a travels in a direction that is partially aligned with the flow of the fluid 1010, so that the first delay time Δt₁ is less than a delay time when the fluid 1010 is not moving in the fluid flow channel 1006.

Also during operation of the ultrasonic fluid flow measurement system 1000, the second ultrasonic transducer 1002b provides a second transmitted ultrasonic signal 1016b at a second angle 1018b toward the first ultrasonic transducer 1002a, at a second time t₂. The second angle 1018b is determined with respect to a perpendicular direction from the second fluid boundary surface 1012b, and is equal to the first angle 1018b when the first fluid boundary surface 1012a is parallel to the second fluid boundary surface 1012b. The second transmitted ultrasonic signal 1016b provides a second received ultrasonic signal 1020b which is acquired by the first ultrasonic transducer 1002a after a second delay time Δt₂. The second transmitted ultrasonic signal 1016b travels in a direction that is partially opposite to the flow of the fluid 1010, so that the second delay time Δt₂ is greater than the delay time when the fluid 1010 is not moving in the fluid flow channel 1006.

FIG. 11 is a chart 1100 depicting example waveforms of the transmitted ultrasonic signals 1016a and 1016b and the received ultrasonic signals 1020a and 1020b, described in reference to FIG. 10. In this example, the first transmitted ultrasonic signal 1016a may be provided as a burst of pulses at time t₁, which provides the first received ultrasonic signal 1020a after the first time delay Δt₁. Similarly, the second transmitted ultrasonic signal 1016b may be provided as a burst of pulses at time t₂, which provides the second received ultrasonic signal 1020b after the second time delay Δt₂.

For the case when the first fluid boundary surface 1012a and the second fluid boundary surface 1012b of FIG. 10 are parallel, the speed v of the fluid 1010 through the fluid flow channel 1006 may be estimated using Equation 5:

v=[w/(2×sin(θ)×sin(θ))]×[(Δt₂−Δt₁₀)/(Δt₂×Δt₁)] Equation 5

Where θ is the first angle 1018a and the second angle 1018b.

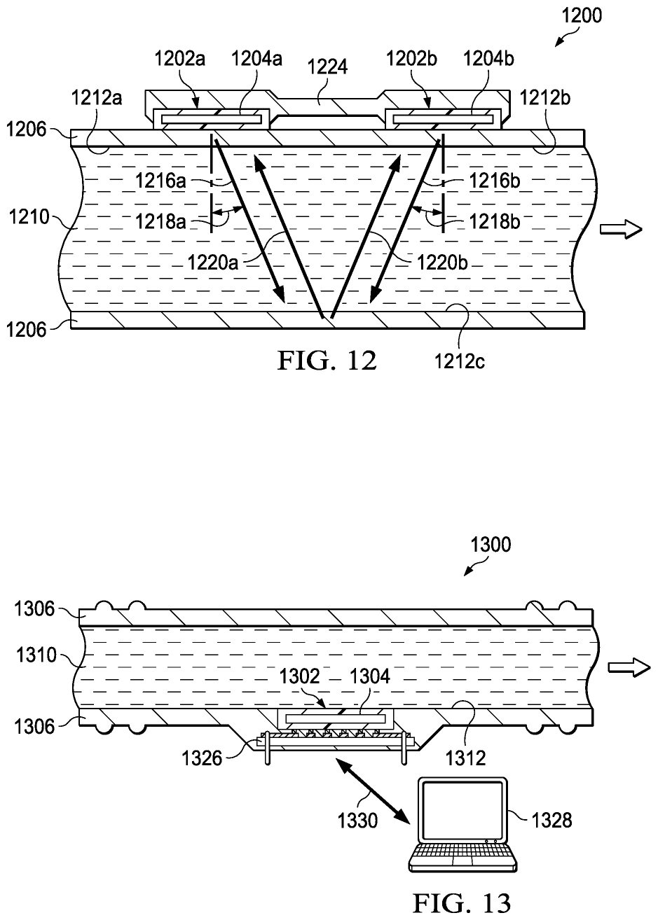

FIG. 12 is a cross section of another example ultrasonic fluid flow measurement system 1200. The ultrasonic fluid flow measurement system 1200 of this example includes a first ultrasonic transducer 1202a and a second ultrasonic transducer 1202b. The first ultrasonic transducer 1202a and a second ultrasonic transducer 1202b may optionally be joined by a connection structure 1224, as indicated in FIG. 12. The first ultrasonic transducer 1202a includes a first array of ferroelectric resonators 1204a, and the second ultrasonic transducer 1202b includes a second array of ferroelectric resonators 1204b. The ultrasonic transducers 1202a and 1202b may be similar to any of the ultrasonic transducers 100, 200, and 300 described in reference to FIG. 1A and FIG. 1B, FIG. 2A and FIG. 2B, and FIG. 3A and FIG. 3B, respectively. The first ultrasonic transducer 1202a and the second ultrasonic transducer 1202a are acoustically coupled to a first side of a fluid flow channel 1206, and laterally displaced from each other, as depicted in FIG. 12. During operation of the ultrasonic fluid flow measurement system 1200, a fluid 1210 may be flowing through the fluid flow channel 1206. The fluid flow channel 1206 has a first fluid boundary surface 1212a adjacent to the first ultrasonic transducer 1202a and a second fluid boundary surface 1212b adjacent to the second ultrasonic transducer 1202b. The first fluid boundary surface 1212a and the second fluid boundary surface 1212b are located on a same side of the fluid flow channel 1206. The fluid flow channel 1206 has a third fluid boundary surface 1212c located opposite from the first fluid boundary surface 1212a and the second fluid boundary surface 1212b. The fluid 1210 contacts the first fluid boundary surface 1212a, the second fluid boundary surface 1212b, and the third fluid boundary surface 1212c. The first array of ferroelectric resonators 1204a and the second array of ferroelectric resonators 1204b are parallel to the first fluid boundary surface 1212a and the second fluid boundary surface 1212b, respectively. The first fluid boundary surface 1212a and the second fluid boundary surface 1212b are parallel to the third fluid boundary surface 1212c.

During operation of the ultrasonic fluid flow measurement system 1200, the first ultrasonic transducer 1202a provides a first transmitted ultrasonic signal 1216a at a first angle 1218a through the fluid 1210 toward the third fluid boundary surface 1212c. The first transmitted ultrasonic signal 1216a reflects off the third fluid boundary surface 1212c and travels through the fluid 1210 toward the second ultrasonic transducer 1202b. The first angle 1218a is determined with respect to a perpendicular direction from the first fluid boundary surface 1212a. The first transmitted ultrasonic signal 1216a provides a first received ultrasonic signal 1220a which is acquired by the second ultrasonic transducer 1202b after a first delay time Δt₁. The first transmitted ultrasonic signal 1216a travels in a direction that is partially aligned with the flow of the fluid 1210, so that the first delay time Δt₁ is less than a delay time when the fluid 1210 is not moving in the fluid flow channel 1206.

Also during operation of the ultrasonic fluid flow measurement system 1200, the second ultrasonic transducer 1202b provides a second transmitted ultrasonic signal 1216b at a second angle 1218b toward the third fluid boundary surface 1212c. The second transmitted ultrasonic signal 1216b reflects off the third fluid boundary surface 1212c and travels through the fluid 1210 toward the first ultrasonic transducer 1202a. The second angle 1218b is determined with respect to a perpendicular direction from the second fluid boundary surface 1212b, and is equal to the first angle 1218b. The second transmitted ultrasonic signal 1216b provides a second received ultrasonic signal 1220b which is acquired by the first ultrasonic transducer 1202a after a second delay time Δt₂. The second transmitted ultrasonic signal 1216b travels in a direction that is partially opposite to the flow of the fluid 1210, so that the second delay time Δt₂ is greater than the delay time when the fluid 1210 is not moving in the fluid flow channel 1206.

A speed of the fluid 1210 though the fluid flow channel 1206 may be estimated using the first delay time Δt₁ and the second delay time Δt₂, in a manner analogous to the method described in reference to FIG. 10 and FIG. 11. Having the first ultrasonic transducer 1202a and the second ultrasonic transducer 1202b joined by the connection structure 1224 may advantageously facilitate installation of the ultrasonic fluid flow measurement system 1200.

FIG. 13 depicts a cutaway view of an example ultrasonic fluid flow measurement system 1300. The ultrasonic fluid flow measurement system 1300 includes an ultrasonic transducer 1302 having an array of ferroelectric resonators 1304. The ultrasonic transducer 1302 may be similar to any of the ultrasonic transducers 100, 200, and 300 described in reference to FIG. 1A and FIG. 1B, FIG. 2A and FIG. 2B, and FIG. 3A and FIG. 3B, respectively. The ultrasonic fluid flow measurement system 1300 of this example includes a fluid flow channel 1306 permanently attached to the ultrasonic transducer 1302. The ultrasonic transducer 1302 may extend through a portion of the fluid flow channel 1306, so that the ultrasonic transducer 1302 is exposed to a fluid 1310 flowing through the fluid flow channel 1306 during operation of the ultrasonic fluid flow measurement system 1300. A surface of the ultrasonic transducer 1302 that is exposed in the fluid flow channel 1306 provides a fluid boundary surface 1312 parallel to the array of ferroelectric resonators 1304. The ultrasonic fluid flow measurement system 1300 may operate as described in reference to either of the ultrasonic fluid flow measurement systems 500 or 800, described in reference to FIG. 5 through FIG. 7, or FIG. 8 and FIG. 9, respectively.

The ultrasonic fluid flow measurement system 1300 may include an interface board 1326 which provides connections to the ultrasonic transducer 1302. The interface board 1326 may include communication circuitry which enable communication of the ultrasonic fluid flow measurement system 1300 with a user interface 1328, depicted in FIG. 13 as a laptop computer. Other manifestations of the user interface 1328 are within the scope of this example. The ultrasonic fluid flow measurement system 1300 may communicate with the user interface 1328 through a communication channel 1330, which may be implemented as a wiring cable, a fiber optic cable, a cellular phone channel, or a wireless channel using a protocol such as IEEE 802.15.1, commonly referred to as Bluetooth, or IEEE 802.11, commonly referred to as WiFi or WLAN. Other modes of communication for the communication channel 1330 between the ultrasonic fluid flow measurement system 1300 and the user interface 1328 are within the scope of this example.

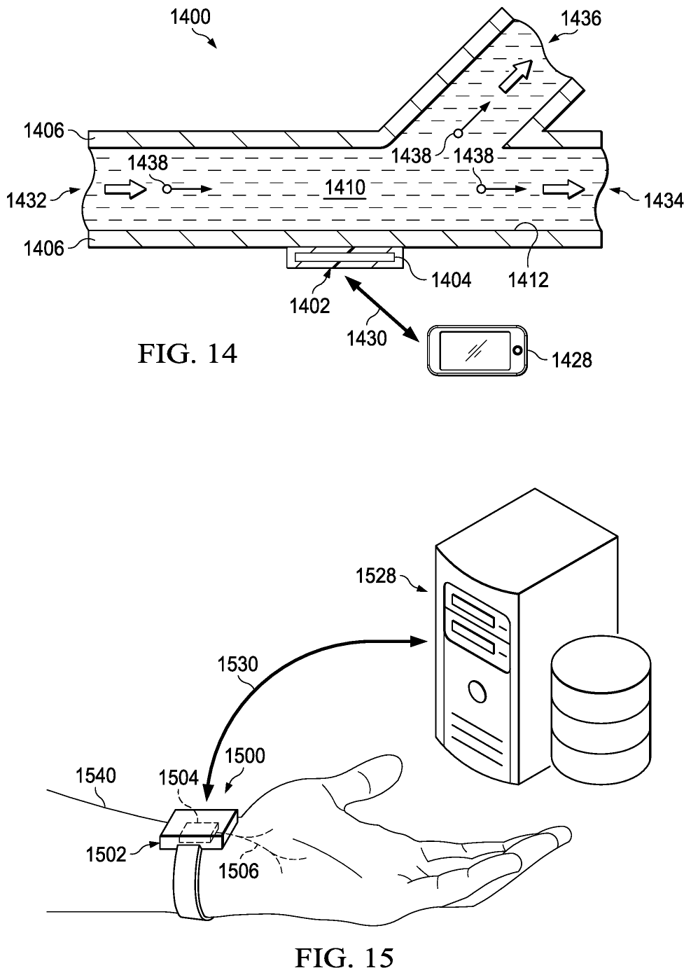

FIG. 14 depicts a cutaway view of another example ultrasonic fluid flow measurement system 1400. The ultrasonic fluid flow measurement system 1400 includes an ultrasonic transducer 1402 having an array of ferroelectric resonators 1404. The ultrasonic transducer 1402 may be similar to any of the ultrasonic transducers 100, 200, and 300 described in reference to FIG. 1A and FIG. 1B, FIG. 2A and FIG. 2B, and FIG. 3A and FIG. 3B, respectively. The ultrasonic transducer 1402 is acoustically coupled to a fluid flow channel 1406; the ultrasonic transducer 1402 may be permanently or removably attached to the fluid flow channel 1406.

The fluid flow channel 1406 has a fluid boundary surface 1412 adjacent to, and parallel to, the array of ferroelectric resonators 1404. The fluid flow channel 1406 of this example has an fluid inlet 1432, a first fluid outlet 1434, and a second fluid outlet 1436. During operation of the ultrasonic fluid flow measurement system 1400, a fluid 1410 flows into the fluid flow channel 1406 through the fluid inlet 1432, and flows out of the fluid flow channel 1406 through the first fluid outlet 1434 and the second fluid outlet 1436. The fluid 1410 includes particles 1438 that flow with the fluid 1410 through the fluid flow channel 1406. The ultrasonic transducer 1402 is located proximate to a junction between the fluid inlet 1432, the first fluid outlet 1434, and the second fluid outlet 1436, so as to enable the ultrasonic transducer 1402 to measure speeds of the particles 1438 in the fluid inlet 1432 and in the first fluid outlet 1434, in the second fluid outlet 1436, or in both the first fluid outlet 1434 and the second fluid outlet 1436. The ultrasonic fluid flow measurement system 1400 may operate as described in reference to either of the ultrasonic fluid flow measurement systems 500 or 800, described in reference to FIG. 5 through FIG. 7, or FIG. 8 and FIG. 9, respectively.

The ultrasonic fluid flow measurement system 1400 may communicate with a user interface 1428, depicted in FIG. 14 as a handheld device such as a smart phone. Other manifestations of the user interface 1428 are within the scope of this example. The ultrasonic fluid flow measurement system 1400 may communicate with the user interface 1428 through a communication channel 1430, which may be implemented as any of the examples described in reference to the communication channel 1330 of FIG. 13. Other modes of communication between the ultrasonic fluid flow measurement system 1400 and the user interface 1428 are within the scope of this example.

FIG. 15 depicts another example ultrasonic fluid flow measurement system 1500. The ultrasonic fluid flow measurement system 1500 of this example may be used to measure flow of blood in a live subject 1540. The ultrasonic fluid flow measurement system 1500 includes an ultrasonic transducer 1502 having an array of ferroelectric resonators 1504. The ultrasonic transducer 1502 may be similar to any of the ultrasonic transducers 100, 200, and 300 described in reference to FIG. 1A and FIG. 1B, FIG. 2A and FIG. 2B, and FIG. 3A and FIG. 3B, respectively. The ultrasonic transducer 1502 is acoustically coupled to a fluid flow channel 1506; the ultrasonic transducer 1502 of this example is manifested as an artery of the live subject 1540, as indicated in FIG. 15. The ultrasonic fluid flow measurement system 1500 may operate as described in reference to either of the ultrasonic fluid flow measurement systems 500 or 800, described in reference to FIG. 5 through FIG. 7, or FIG. 8 and FIG. 9, respectively. The ultrasonic fluid flow measurement system 1500 may communicate with a user interface 1528, depicted in FIG. 15 as a remote server. Other manifestations of the user interface 1528 are within the scope of this example. The ultrasonic fluid flow measurement system 1500 may communicate with the user interface 1528 through a communication channel 1530, which may be implemented as any of the examples described in reference to the communication channel 1330 of FIG. 13. Other modes of communication between the ultrasonic fluid flow measurement system 1500 and the user interface 1528 are within the scope of this example. Modifications are possible in the described embodiments, and other embodiments are possible, within the scope of the claims.

What is claimed is:

1. An ultrasonic fluid flow transducer, comprising:
a substrate including a semiconductor material;
an interconnect region on the substrate;
an array of first ferroelectric resonators in the interconnect region;
an array of second ferroelectric resonators in the interconnect region;
ultrasonic reflectors in the interconnect region at ends of the array of first ferroelectric resonators and the array of second ferroelectric resonators;
a transmitter circuit including first active components in the semiconductor material, the transmitter circuit being configured to actuate the first ferroelectric resonators to provide a first ultrasonic signal; and
a detector circuit including second active components in the semiconductor material, the detector circuit being configured to detect a second ultrasonic signal acquired by the second ferroelectric resonators.

2. The ultrasonic fluid flow transducer of claim 1, wherein the array of first ferroelectric resonators includes ferroelectric resonators of the array of second ferroelectric resonators.

3. The ultrasonic fluid flow transducer of claim 2, wherein the transmitter circuit is coupled to the array of first ferroelectric resonators through a multiplexer, and the detector circuit is coupled to the array of second ferroelectric resonators through the multiplexer.

4. The ultrasonic fluid flow transducer of claim 1, wherein the transmitter circuit is a first transmitter circuit and the detector circuit is a first detector circuit, and further comprising:
an array of third ferroelectric resonators in the interconnect region;
an array of fourth ferroelectric resonators in the interconnect region;
a second transmitter circuit located at least partly in the substrate, the transmitter circuit being coupled to the array of third ferroelectric resonators; and
a second detector circuit located at least partly in the substrate, the second detector circuit being coupled to the array of fourth ferroelectric resonators.

5. The ultrasonic fluid flow transducer of claim 1, wherein the array of first ferroelectric resonators includes a first subarray of the first ferroelectric resonators and a second subarray of the first ferroelectric resonators, and the ultrasonic fluid flow transducer includes a grating in the interconnect region located between the first subarray and the second subarray.

6. The ultrasonic fluid flow transducer of claim 1, wherein the array of first ferroelectric resonators is configured to concurrently transmit a first ultrasonic signal at a first angle with respect to a perpendicular direction from a plane of the array of first ferroelectric resonators and transmit a second ultrasonic signal at a second angle with respect to a perpendicular direction.

7. The ultrasonic fluid flow transducer of claim 1, wherein the array of first ferroelectric resonators is configured to transmit an ultrasonic signal at an angle with respect to a perpendicular direction from a plane of the array of first ferroelectric resonators, wherein the transmitter circuit is configured to vary the angle by varying a phase applied to the array of first ferroelectric resonators.

8. The ultrasonic fluid flow transducer of claim 1, wherein the array of first ferroelectric resonators is configured to transmit an ultrasonic signal through a top surface of the interconnect region, opposite from the substrate.

9. The ultrasonic fluid flow transducer of claim 1, wherein the array of first ferroelectric resonators is configured to transmit an ultrasonic signal through the substrate.

10. An ultrasonic fluid flow measurement system, comprising:
an ultrasonic fluid flow transducer, including:
a substrate including a semiconductor material;
an interconnect region on the substrate;
an array of first ferroelectric resonators in the interconnect region;
an array of second ferroelectric resonators in the interconnect region;
a transmitter circuit including first active components in the semiconductor material, the transmitter circuit being coupled to the array of first ferroelectric resonators, wherein the transmitter circuit is configured to actuate the first ferroelectric resonators to emit a first ultrasonic signal into a fluid flow channel attached to the ultrasonic fluid flow transducer; and
a detector circuit including second active components in the semiconductor material, the detector circuit being coupled to the array of second ferroelectric resonators, wherein the detector circuit is configured to provide a detection signal corresponding to acquisition of a second ultrasonic signal from the fluid flow channel, by the second ferroelectric resonators.

11. The ultrasonic fluid flow measurement system of claim 10, wherein the detection signal is a frequency shift signal corresponding to a difference between a frequency of the first ultrasonic signal and a frequency of the second ultrasonic signal.

12. The ultrasonic fluid flow measurement system of claim 10, wherein the detection signal is a delay time signal corresponding to a time difference between emission of the first ultrasonic signal and detection of the second ultrasonic signal.

13. The ultrasonic fluid flow measurement system of claim 10, wherein the array of first ferroelectric resonators is configured to concurrently transmit a first ultrasonic signal at a first angle with respect to a perpendicular direction from a plane of the array of first ferroelectric resonators and transmit a second ultrasonic signal at a second angle with respect to a perpendicular direction.

14. The ultrasonic fluid flow measurement system of claim 10, wherein the array of first ferroelectric resonators is configured to transmit an ultrasonic signal at an angle with respect to a perpendicular direction from a plane of the array of first ferroelectric resonators, wherein the transmitter circuit is configured to vary the angle by varying a phase applied to the array of first ferroelectric resonators.

15. An ultrasonic fluid flow measurement system, comprising:
an ultrasonic fluid flow transducer, including:
a substrate including a semiconductor material;
an interconnect region on the substrate;
an array of first ferroelectric resonators in the interconnect region, the array of first ferroelectric resonators being parallel to a fluid boundary surface of a fluid flow channel attached to the ultrasonic fluid flow transducer;
a transmitter circuit including first active components in the semiconductor material, the transmitter circuit being coupled to the array of first ferroelectric resonators, wherein the transmitter circuit is configured to actuate the first ferroelectric resonators to emit an ultrasonic signal into the fluid flow channel;
an array of second ferroelectric resonators in the interconnect region, the array of second ferroelectric resonators being parallel to the fluid boundary surface; and
a detector circuit including second active components in the semiconductor material, the detector circuit being coupled to the array of second ferroelectric resonators, wherein the detector circuit is configured to provide a detection signal corresponding to detection of a reflection of the ultrasonic signal from the fluid flow channel, by the second ferroelectric resonators.

16. The ultrasonic fluid flow measurement system of claim 15, wherein the ultrasonic fluid flow transducer is permanently attached to the fluid flow channel.

17. The ultrasonic fluid flow measurement system of claim 15, wherein:
the fluid flow channel has exactly one fluid inlet and exactly one fluid outlet;
the ultrasonic fluid flow transducer is located between the fluid inlet and the fluid outlet; and
the array of first ferroelectric resonators is configured to transmit a first ultrasonic signal into the fluid flow channel in a direction toward the fluid inlet and to transmit a second ultrasonic signal into the fluid flow channel in a direction toward the fluid outlet.

18. The ultrasonic fluid flow measurement system of claim 15, wherein:
the fluid flow channel has exactly one fluid inlet, a first fluid outlet, and a second fluid outlet;
the ultrasonic fluid flow transducer is located between the fluid inlet and the first fluid outlet; and
the array of first ferroelectric resonators is configured to transmit a first ultrasonic signal into the fluid flow channel in a direction toward the fluid inlet and to transmit a second ultrasonic signal into the fluid flow channel in a direction toward the second fluid outlet.

19. An ultrasonic fluid flow measurement system, comprising:
a first ultrasonic fluid flow transducer, including:
a first substrate including a first semiconductor material;
a first interconnect region on the first substrate;
an array of first ferroelectric resonators in the first interconnect region, the array of first ferroelectric resonators being parallel to a first fluid boundary surface of a fluid flow channel attached to the first ultrasonic fluid flow transducer;
an array of second ferroelectric resonators in the first interconnect region, the array of second ferroelectric resonators being parallel to the first fluid boundary surface;
a first transmitter circuit including first active components in the first semiconductor material, the first transmitter circuit being coupled to the array of first ferroelectric resonators, wherein the first transmitter circuit is configured to actuate the first ferroelectric resonators to emit a first ultrasonic signal into the fluid flow channel; and
a first detector circuit including second active components in the first semiconductor material, the first detector circuit being coupled to the array of second ferroelectric resonators, wherein the first detector circuit is configured to provide a first detection signal corresponding to detection of a second ultrasonic signal through the fluid flow channel, by the second ferroelectric resonators; and
a second ultrasonic fluid flow transducer, including:
a second substrate including a second semiconductor material;
a second interconnect region on the second substrate;
an array of third ferroelectric resonators in the second interconnect region, the array of third ferroelectric resonators being parallel to a second fluid boundary surface of the fluid flow channel;
an array of fourth ferroelectric resonators in the second interconnect region, the array of fourth ferroelectric resonators being parallel to the second fluid boundary surface;
a second transmitter circuit including third active components in the second semiconductor material, the second transmitter circuit being coupled to the array of third ferroelectric resonators, wherein the second transmitter circuit is configured to actuate the third ferroelectric resonators to emit the second ultrasonic signal into the fluid flow channel; and
a second detector circuit including fourth active components in the second semiconductor material, the second detector circuit being coupled to the array of fourth ferroelectric resonators, wherein the second detector circuit is configured to provide a second detection signal corresponding to detection of the first ultrasonic signal through the fluid flow channel, by the fourth ferroelectric resonators.

20. The ultrasonic fluid flow measurement system of claim 19, wherein the first fluid boundary surface and the second fluid boundary surface are located on a same side of the fluid flow channel.
